(19) United States
(12) Patent Application Publication
(10) Pub. No.: US 2013/0329938 A1
(43) Pub. Date: Dec. 12, 2013

(54) ENCODING DIGITAL ASSETS ALONG WITH CONTENT CONTROL DATA AS A QUILTED IMAGE REPRESENTATION

(71) Applicants: Jorg-Ulrich Mohnen, West Hollywood, CA (US); Mark Beaven, Los Angeles, CA (US)

(72) Inventors: Jorg-Ulrich Mohnen, West Hollywood, CA (US); Mark Beaven, Los Angeles, CA (US)

(21) Appl. No.: 13/494,229

(22) Filed: Jun. 12, 2012

(51) Int. Cl. G06T 9/00

(52) U.S. Cl. 382/100

(57) ABSTRACT

The present invention extends to methods, systems, and computer program products for encoding digital assets along with content control data as an image. Portions of a digital asset (e.g., audio data, video data, geospatial data, etc.) are encoded as series of graphical representations. One or more portions of the series of graphical representations are replaced with content control data. Content control data can be placed in a series of graphical representations in a manner that makes the presence of the content control data difficult to detect (e.g., based on the principles of steganography). Two dimensional images can be lossless relative to corresponding digital assets. Encoding can take redundancies between successive graphic image representations into account, reducing (potentially substantially) resource consumption when storing and transmitting digital assets.

### CROSS-REFERENCE TO RELATED APPLICATIONS

Not Applicable.

### BACKGROUND

1. Background and Relevant Art

Computer systems and related technology affect many aspects of society. Indeed, the computer system's ability to process information has transformed the way we live, work, and interact. Computer systems now commonly perform a host of tasks (e.g., word processing, scheduling, accounting, communicating, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks is distributed across a number of different computer systems and/or a number of different computing environments.

In some computing environments, transfer of data between computer systems includes one computer system downloading digital assets (e.g., a file, song, movie, data set, etc) from another computer system. In these computing environments, the downloading computer system can utilize the digital assets locally after downloading (e.g., opening a file, playing a song, etc). In other computing environments, transfer of data between computer systems includes sending computer system streaming digital assets to a receiving computer system. In these other computing environments, the receiving computer system can utilize or interact with portions of digital assets as they are received (e.g., playing a portion of a movie or song).

In these and other computing environments, the transferred digital assets consume sizeable computing resources (reflected, for example, in storage space, RAM, network bandwidth, etc.). In general, the larger the digital asset the more computing resources are consumed for storage and transfer of the digital asset. As such, various mechanisms find themselves employed to facilitate more efficient use of computing resources. For example, various transformation and data compression algorithms can be used to reduce digital asset sizes.

Lossy and lossless compression methods can be used. Lossy compression algorithms provide greater compression rates at the cost of losing some amount of a digital asset during compression. In some environments, lossy compression is preferred, such as, for example, when some loss of a digital asset is acceptable or perhaps is even imperceptible to a user (e.g., song quality may be degraded but the degradation is mostly imperceptible to the human ear or as afforded via the method of playback). Lossless compression algorithms provide lesser compression rates. However, there is limited, if any, loss of a digital asset during lossless compression.

When transferring digital assets between computer systems it is also often difficult control access to the digital assets. With respect to digital assets, access control can include elements of authentication, authorization, and audit. Access control for digital assets is typically falls into one of two classes: those based on capabilities and those based on Access Control Lists (“ACLs”).

Conditional Access is the protection of content by requiring certain criteria to be met before granting access to this content. Conditional Access (CA) is the system that has traditionally been used to protect TV channels. The standards are tightly-defined and provide a method by which a digital television stream can be scrambled. The only people who can descramble, and thus watch, the picture are those with the right receiving box and valid keys. A Digital Rights Management system, however, is asset driven. The main difference between CA and DRM is that DRM is usually applied to a specific piece of content and a specific user(s).

In a capability-based model, holding an unforgettable reference or capability to an object provides access to the object (roughly analogous to how possession of your house key grants you access to your house). Access is conveyed to another party by transmitting such a capability over a secure channel. In an ACL-based model, a subject's access to an object depends on whether its identity is on a list associated with the object (roughly analogous to how authorities would check a traveler's passport, for example, when entering a country). Access is conveyed by editing the list.

Digital Rights Management (“DRM”) is an example of a capability model. DRM technologies attempt to give a creator or seller control of their digital asset after the digital asset has been given to another party, such as, a consumer. For example, DRM technologies enable content publishers to enforce their own access policies on content, like restrictions on copying or viewing. DRM techniques include restrictive license agreements, encryption, scrambling of expressive material, and embedding tags.

Digital watermarks are features of digital assets that are added during production or distribution. Watermarks can be used for different purposes including recording the copyright owner, recording the distributor, recording the distribution chain, and identifying the purchaser of the asset. Watermarks are not complete DRM mechanisms in their own right, but are used as part of a system for Digital Rights Management, such as helping provide prosecution evidence for purely legal avenues of rights management, rather than direct technological restriction.

Sometimes, metadata is included in purchased asset which records information such as the purchaser's name, account information, or email address. This information is not embedded in the played data, like a watermark, but is kept separate, but within the file or stream. As an example, metadata is used in media purchased from online application stores for DRM-free as well as DRM-restricted versions of their music or videos. This information can be included as MPEG standard metadata.

However, there are many methods to bypass DRM control of digital assets including audio and video content. One method to bypass DRM on audio files is to burn the content to an audio CD and then rip it into DRM-free files. There are also many software programs that intercept the data stream as it is decrypted out of the DRM-restricted file, and then use this data to construct a DRM-free file. Watermarks can typically be removed from digital assets.

Most, if not all, digital assets are also subject to the “analog hole”. That is, to output a digital asset a digital signal must at some point be turned into an analog signal. For example, in order for an audio player to play an audio file, the digital signal must be turned into an analog signal containing light and/or sound for the player. DRM is not capable of controlling content in analog form. Thus, a user can record or otherwise manipulate an analog signal outside the control of DRM techniques used on the corresponding digital asset. For example, a user could play a purchased audio file while using a separate program to record the sound back into the computer in a DRM-free file format.

### BRIEF SUMMARY

The present invention extends to methods, systems, and computer program products for encoding digital assets along with content control data as a quilted image representation. Embodiments of the invention include staging a digital asset. Conversion properties are selected for the digital asset. The conversion properties include image properties for a two dimensional image, having one or more rows and one or more columns, used to store portions of the digital asset. The image properties include a row size that indicates the size for any rows in the two dimensional image and include a column size that indicates the size for any columns in the two dimensional image. The conversion properties also include content control data (e.g., digital rights management data or content access data) for implementing content control (e.g., digital rights management or content access) for the digital asset.

The digital asset and the content control data are quilted into the one or more rows and one or more columns of the two dimensional image. For at least a subset of the portions of the digital asset that are to be stored in the two dimensional image, quilting includes converting the portion of the digital asset into a series of graphic representations in accordance with the selected conversion properties. For the at least a subset of the portions of the digital asset that are to be stored in the two dimensional image, quilting includes replacing part of at least one graphical representation included in the series of graphical representations with a portion of the content control data. For the at least a subset of the portions of the digital asset that are to be stored in the two dimensional image, quilting includes encoding the portion of the content control data into the two dimensional image by encoding the series of graphic representations into a row and column of the two dimensional image.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates encoding digital assets along with content control data as a quilted image representation.

FIG. 2 illustrates a flow chart of an example method for encoding digital assets along with content control data as a quilted image representation.

### DETAILED DESCRIPTION

The present invention extends to methods, systems, and computer program products for encoding digital assets along with content control data as a quilted image representation. Embodiments of the invention include staging a digital asset. Conversion properties are selected for the digital asset. The conversion properties include image properties for a two dimensional image, having one or more rows and one or more columns, used to store portions of the digital asset. The image properties include a row size that indicates the size for any rows in the two dimensional image and include a column size that indicates the size for any columns in the two dimensional image. The conversion properties also include content control data (e.g., digital rights management data or content access data) for implementing content control (e.g., digital rights management or content access) for the digital asset.

The digital asset and the content control data are quilted into the one or more rows and one or more columns of the two dimensional image. For at least a subset of the portions of the digital asset that are to be stored in the two dimensional image, quilting includes converting the portion of the digital asset into a series of graphic representations in accordance with the selected conversion properties. For the at least a subset of the portions of the digital asset that are to be stored in the two dimensional image, quilting includes replacing part of at least one graphical representation included in the series of graphical representations with a portion of the content control data. For the at least a subset of the portions of the digital asset that are to be stored in the two dimensional image, quilting includes encoding the portion of the content control data into the two dimensional image by encoding the series of graphic representations into a row and column of the two dimensional image.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. Any of these computer system configurations can have a local storage device to access digital assets stored thereon. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. It can also be a local content access control.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

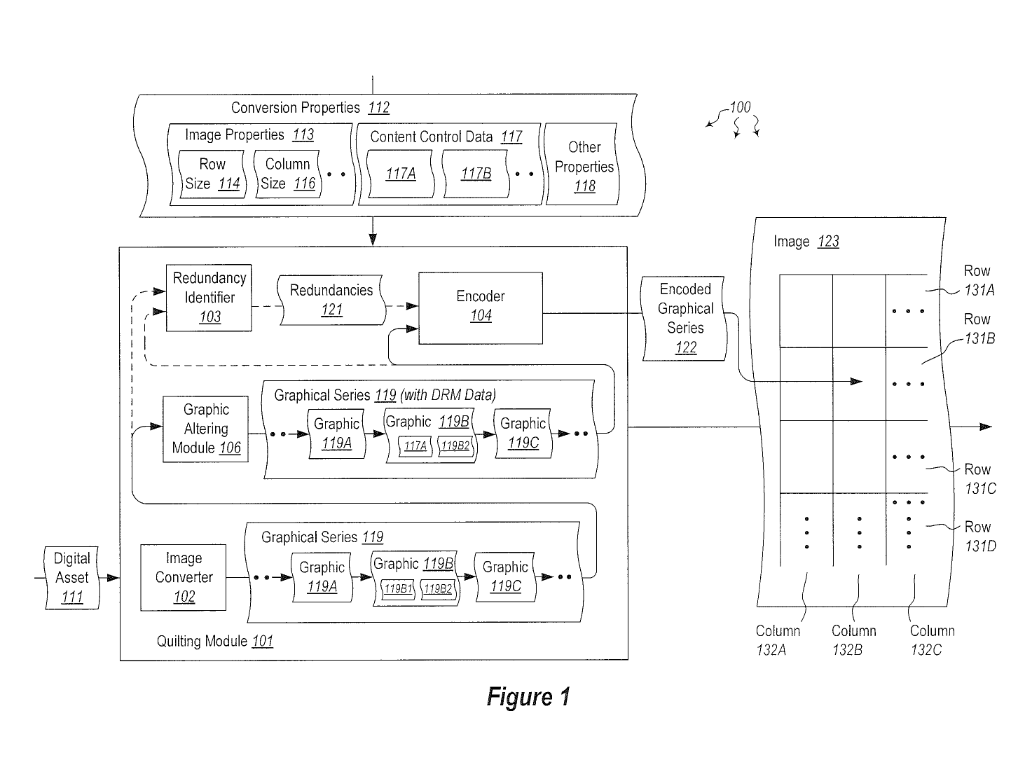

FIG. 1 illustrates an example computer architecture 100 that facilitates encoding digital assets along with content control data as a quilted image representation. Referring to FIG. 1, computer architecture 100 includes quilting module 101. Quilting module 101 is connected to (or is part of) a network, such as, for example, a Local Area Network (“LAN”), a Wide Area Network (“WAN”), and even the Internet. Accordingly, quilting module 101 as well as any other connected computer systems and their components, can create message related data and exchange message related data (e.g., Internet Protocol (“IP”) datagrams and other higher layer protocols that utilize IP datagrams, such as, Transmission Control Protocol (“TCP”), File Transfer Protocol (“FTP”), Secure Copy Protocol (“SCP”), Hypertext Transfer Protocol (“HTTP”), Simple Mail Transfer Protocol (“SMTP”), etc.) over the network

In general, quilting module 101 is configured to quilt a digital asset along with digital rights management data into one or more or rows and one or more columns of a two dimensional image in accordance with conversion properties. A digital asset can be virtually any type of digital object, including but not limited to: imagery data, audio data, video data, gaming data, financial data, trading data, broadcast data, radio data, digital books, and geo-spatial data. A two dimensional image can include: sets of one or more one dimensional single image frames, two dimensional single image frames, a three dimension image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset, and various other assets including a larger set of images quilted together to form the largest image quilt.

Conversion properties can include image properties for the two dimensional image, such as, for example, a number of rows for the two dimensional image, a number of columns for the two dimensional image, a row size that indicates the size for any rows in the two dimensional image, and a column size that indicates the size for any columns in the two dimensional image. Conversion properties can also include other properties for the two dimensional image: data rate frequency (e.g., ranging from 2 Hz through 256 kHz), bit depth (e.g., ranging from 2 bit through 64 bit), an indication if bit depth is variable, a number of channels (e.g., ranging from 1 channel to multispectral or hyperspectral), processing type (e.g., discreet or non-discreet processing), data type (e.g., floating point or integer), scan type (e.g., interlaced or progressive), and encoding scheme (e.g., band interleaved by part/pixel (“BIP”), band interleaved by line (“BIL”), or band sequential (“BSQ”)). Conversion properties can also include content control data, such as, for example, Digital Rights Management (“DRM”) data and/or Content (or Conditional) Access (“CA”) data, used to facilitate content control for a digital asset.

As depicted, quilting module 101 further includes image converter 102, redundancy identifier 103, encoder 104, and graphic replacement module 106. Image converter 102 is configured to convert a portion of a digital asset into a series of graphic representations in accordance with the selected conversion properties. For example, image converter 102 can convert a set or sub-set of a digital asset (e.g., video frames, sound, game textures, imagery data, broadcast data, financial data, trading data, radio data, digital book data, or geospatial data) into a series of graphic image representations for quilting into a two dimensional image.

Graphic altering module 106 is configured to introduce parts of graphical representations with content control data, such as, for example, DRM data and/or CA data. Graphic altering module 106 can be configured to introduce part of a graphical representation with content control data, or can be configured holistically to introduce the whole of a graphical representation with content control data. Introduction of content control data can be in accordance with the principles of steganography (a form of security through obscurity).

That is, graphic altering module 106 can introduce content control data into a graphical representation such that it is difficult for anyone without prior knowledge (e.g., anyone besides the sender and intended recipient) to detect (or even suspect) that content control data is included in the graphical representation. Alternately or in combination, graphic altering module 106 can be configured to hide content control data in a graphical representation such that content control data does not attract attention. For example, DRM data and/or CA data can be embedded into part of graphical representation corresponding to inaudible and/or non-visible portions of audio/video digital assets.

Redundancy identifier 103 is configured to identifying redundancies between successive graphic representations in series of graphic representations. For example, redundancy identifier 103 can identify portions of successive graphics representing the same visual data or audio data. Redundancy identifier 103 can arrange a data structure such that there is no need to retain complete graphic representations multiple times when the same visual or audio data is represented.

Encoder 104 is configured to encode content control data, such as, for example, DRM data and/or CA data into a two dimensional image by encoding the series of graphic representations into a row and column of the two dimensional image. When appropriate, encoder 104 takes into account the identified redundancies so as to reduce the size of the asset being encoded or quilted.

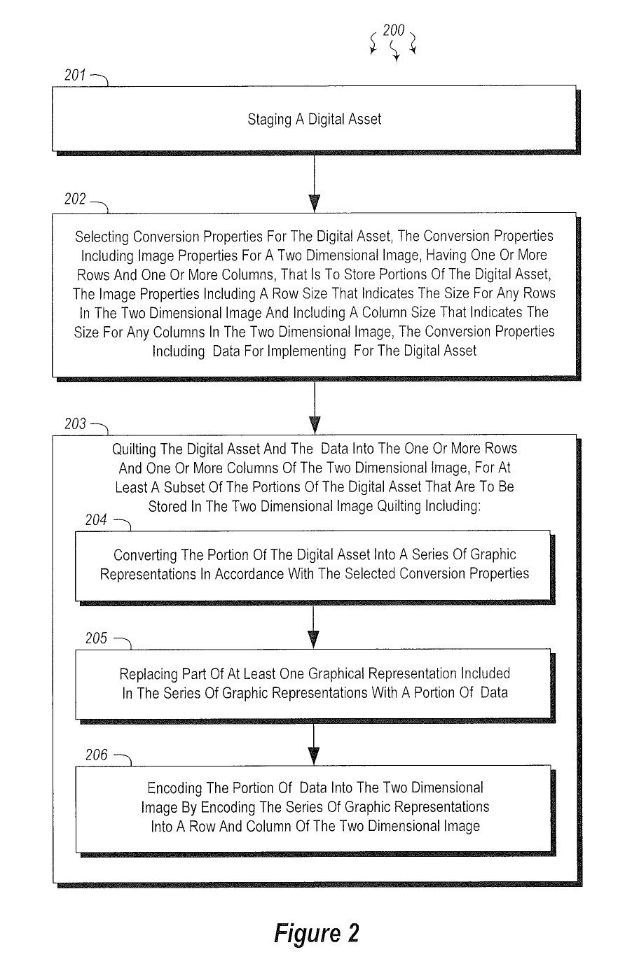

FIG. 2 illustrates a flow chart of an example method 200 for encoding digital assets along with content control data as a quilted image representation. Method 200 will be described with respect to the components and data of computer architecture 100.

Method 200 includes an act of staging a digital asset (act 201). For example, computer system 100 can stage digital asset 111. Digital asset 111 can include one or more of different types of data including but not limited to: imagery data, audio data, video data, gaming data, financial data, trading data, broadcast data, radio data, digital book data, and geo-spatial data. In some embodiments, digital asset 111 includes a single data type. In other embodiments, digital asset 111 includes a plurality of different data types. For example, a digital asset for a navigation system can include audio data, video data, image data, and geo-spatial data.

Method 200 includes an act of selecting conversion properties for the digital asset, the conversion properties including image properties for a two dimensional image, having one or more rows and one or more columns, that is to store at least a portion of the digital asset, the image properties including a row size that indicates the size for any rows in the two dimensional image and including a column size that indicates the size for any columns in the two dimensional image, the conversion properties including content control data (act 202). For example, quilting module 101 can select conversion properties 112, including image properties 113, content control data 117 (e.g., DRM data and/or CA data), other properties 118. Image properties 113 can define the layout of image 123 that is to store at least a portion of digital asset III.

As depicted, image properties 113 include row size 114 and column size 116. Row size 114 can indicate the size of any rows (e.g., rows 131A, 131B, 131C, and 131D etc.) in image 123. Column size 116 can indicate the size of any columns (e.g., columns 132A, 132B, 132C, etc.) in image 123. Image properties 113 can also indicate the number of rows and the numbers of columns for image 123. Other properties 118 can indicate one or more of: a data rate frequency for image 123, a bit depth for image 123, if bit depth is variable for image 123, a number of channels for image 123, a processing type for image 123, a data type for image 123, a scan type for image 123 and an encoding scheme for image 123.

Content control data 117 can store portions of content control data 117A, 117B, etc. that are used to replace portions of graphical representations (e.g., portions of one or more of graphics 119, 119B, 119C). In some embodiments, content control data 117 is based on properties of an operating environment. For example, a module within computer architecture 100 can access properties of the operating environment for computer architecture 100, such as, for example, user information, IP addresses, CPU serial numbers, driver identifiers, mainboard serial number, information hidden/contained in RAM, etc. The module can formulate content control data 117, including DRM data and/or CA data, from the accessed properties.

Method 200 includes an act of quilting the digital asset and the content control data into the one or more rows and one or more columns of the two dimensional image (act 203). For example, quilting module 101 can quilt digital asset 111 along with content control data 117 into rows 131A-131D etc. and columns 132A-132C etc. of image 123. In some embodiments, a portion of content control data 117 (e.g., DRM data and/or CA data) is quilted into each row/column within image 123. Accordingly, content control data 117 is essentially embedded throughout the whole of image 123.

Image 123 can include any of: sets of one or more one dimensional single image frames, two dimensional single image frames, a three dimensional image set, a two dimensional image and/or Lidar set, a two dimensional image and/or point cloud set, a film strip set, a video quilt, single channel audio image, a stereo paired audio signal (e.g., right & left channel), an image quilt of multiple audio channels (i.e. surround sound 7.1 with seven channels), an image quilt of multiple songs in a single digital asset (i.e., digital vinyl), or other assets including a larger set of images quilted together to form the largest image quilt, etc.

For at least a subset of the portions of the digital asset that are to be stored in the two dimensional image, act 203 includes an act of converting the portion of the digital asset into a series of graphic representations in accordance with the selected conversion properties (act 204). For example, image converter 102 can convert a portion of digital asset 111 into graphical series 119 in accordance with conversion properties 112. Graphical series 119 includes graphical representations 119A, 119B, 119C, etc.

Thus, generally, a set or sub set of digital asset 11 l can be converted into a grapic image representation for quilting into image 123. In some embodiments, digital asset 111 includes video frames. In these embodiments, image converter 102 can convert the complete set or sub-set of video frames into a graphic image representation for quilting into image 123. In other embodiments, digital asset 111 includes sound data. In these other embodiments, image converter 102 can convert the complete set or sub-set of sound data into a graphic image representation for quilting into image 123. In further embodiments, digital asset 111 includes game textures. In these further embodiments, image converter 102 can convert the complete set or sub-set of game textures into a graphic image representation for quilting into image 123. In additional embodiments, digital asset 111 includes geospatial data. In these additional embodiments, image converter 102 can convert the complete set or sub-set of geospatial data into a graphic image representation for quilting into image 123. In additional embodiments, digital asset 111 includes other data. In these additional embodiments, image converter 102 can convert the complete set or subset of other data into a graphic image representation for quilting into image 123.

Each graphical representation 119A 119B, 119C, etc. can include smaller portions, such as, for example, pixels or other visual sub components. For example, graphic 119B includes portions 119B1, 119B2, etc.

For at least a subset of the portions of the digital asset that are to be stored in the two dimensional image, act 203 includes an act of replacing part of at least one graphical representation included in the series of graphical representations with a portion of content control data (act 205). For example, graphic alteration module 106 can replace portion 119B1 of graphic 119 with content control data 117A (e.g., a portion of DRM data and/or CA data). Parts of one of more other graphics in graphical series 199, such as, for example, graphic 119A and 119C can also be replaced with content control data from content control data 117. For example, a portion of graphic 119C can be replaced with content control data 117B.

In some embodiments, a digital asset is geotagged. For example, image 111 can be tagged geospatially with fixed coordinates (e.g., included in embedded content control data 133). As part of geospatial tagging, an origin date and origin location of image 111 can be included in image 111 as part of stenographic material. The geospatial information allows image 111 to be tracked, such as, for example, as it passes through network devices on a network. For example, routers, switches, hubs, and computer systems can track image 111 (a content control embedded asset) as it traverses the Internet.

In some embodiments, for each portion of the digital asset that is to be stored in the two dimensional image, act 203 includes an act of identifying redundancies between successive graphic representations in the series of graphic representations. For example, redundancy identifier 103 can access graphical series 119. Redundancy identifier 103 can identify redundancies 121 between successive graphics in graphical series 119, including between graphics 119A, 119B, 119C, etc. Redundancies 121 can identify portions of successive graphics representing the same visual and/or audio data such that there is no need retain the portions of successive graphics multiple times. For example, if 95% of graphic 119A and graphic 119B represent the same video data, 5% of graphic 119B can be retained (or less if there are redundancies with other earlier graphics in graphical series 119).

As depicted, redundancies are identified for graphical series 119 in parallel with placing DRM data 117 into graphical series 119. However, redundancies can also be identified for graphical series 119 after content control data 117 is placed into graphical series 119.

In some embodiments, method 200 includes an act of staging a graphic image representation (e.g., graphical series 119) for further processing. For example, a graphic image representation can be staged for sub-areas and sub-resolutions. A graphic image representation can be staged for storage in a hierarchical pyramidal space. The hierarchical pyramid space can be transmitted level by level; first low resolution data at low transmission bandwidths, then additional detail filled in by transmitting higher resolution levels assuming bandwidth is available. A graphic image representation can be staged to transmit different resolutions depending on transmission capabilities. Edges and distinct values for the graphic image representation can be quantized. Quantized data is then run through a selected encoding technique (e.g., Huffman, IBM's arithmetic encoder for PEG 2000, etc.).

A graphic image representation can be staged for further process prior or subsequent to placing content control data into graphical series used to form the graphic image representation. Content control data can placed into a graphic image representation image for any and all sub-areas and sub-resolutions.

Quilting module 101 can support discreet and/or non-discreet hierarchical data. When processing a discreet hierarchical data set, quantization can be used. Any of a variety of different encoding methods, including rounding and bit chunking, can be used to facilitate quantization.

In some embodiments, a graphic image representation (e.g., graphical series 119) is transformed via a discreet or non-discreet hierarchical data into a space that is naturally structured in a multi-level multi-resolution format. The process is performed on the entire graphic image representation and is converted into a multi-level pyramid of data. For example, the graphic image representation is broken in to line values for each of a plurality of resolution levels. The lines are processed into hierarchically organized multilevel data lines.

Intermediate horizontal lines essentially provide a rolling buffer. One line of true image can be used to generate one line of intermediate horizontal rolling buffer. Thus, one line of input can be read and processed into the horizontal data buffer and then discarded. Two (e.g., of four) down sampled sub-sets can then be generated. The steps can reiterated over the entire graphic image representation to perform a full hierarchical structure of the graphic image representation.

As such, each level is essentially one half the size of the previous level. Thus, the graphic image representation is structured in multi-levels and in a multi-resolution state. This can be, for example, constructing a raw line by line of the graphic image representation→enhanced hierarchical data structuring→quantizer or No Loss→staging encoder→multi-resolution output of the quilted graphic 2D image representation, line by line.

For at least a subset of the portions of the digital asset that are to be stored in the two dimensional image, act 203 includes an act of encoding the portion of content control data into the two dimensional image by encoding the series of graphic representations into a row and column of the two dimensional image. For example, encoder 104 can encode graphical series 119 into encoded graphical series 122 (which includes content control data 117 and takes into account redundancies 121 when appropriate). Encoder 104 can store encoded graphical series 122 into row 131B and column 132B of image 123.

For multi-resolution formats, encoder 104 can determine (potentially automatically) how many resolution levels an image can contain. Essentially any number of resolution levels can be used. For example, there may be 15 levels of resolution for a larger video file, or perhaps only 2 or 3 levels of resolution for a smaller audio file.

For video, different resolution levels can correspond to the format (e.g., of a movie) going from 4 k to 2 k to 1080p to 1080i to 720p etc. Each of these different resolution levels can be quilted along with content control data into a two dimensional image during encoding of video.

For audio, sample frequency is an approximate parallel. For example, a two dimensional image for a portion of audio may be 5000 pixel wide by 40000 pixel long or 200,000,000 pixels. Each pixel can be viewed as a sample. If the portion of audio was 7minutes long, that would be 420 seconds. Thus, within the two dimensional image there is approximately 476,190.48 (200,000,000/420) samples per second of the portion of audio. As samples/second this can be represented by 476,190 Hz or roughly 476 KHz.

Practically, a highest “resolution” detail represents 128 KHz. From there, lower and lower “resolutions” 64 KHz, 32 KHz, etc., down to 2 Hz. In other environments, 44.1 KHz may be the highest resolution and then the next lower resolution which is 22.05 KHz. Each of these different resolution levels can be quilted together along with content control data into a single two dimensional image or into a plurality of two dimensional images during encoding of the portion of audio.

Devices can request that a two dimensional image supply digital asset data (audio, video, etc.) at a specified resolution that is at or below the highest resolution encoded into the two dimensional image. 15 resolution states may be quilted into a two dimensional image representing a digital asset of video data. 15 is the highest resolution (e.g., full 4K) and 1 is the lowest resolution. A device with a lower screen resolution (e.g., a mobile phone or tablet) can “ask the file” to supply it with a resolution state of “5” out of “15”. A device with higher screen resolution (e.g., a workstation editing machine) can request resolution state “15”.

Similarly, 3 resolution states may be quilted into a two dimensional image representing a digital asset of audio data. 3 is the highest resolution (e.g., 96 KHz) and 1 is the lowest resolution (e.g., 22.05 KHz). A device attached to a limited bandwidth network might not want to stream an audio data at a full resolution of “3”. Instead, the device can request a lower resolution, possibly “1”.

As appropriate, image converter 102 and/or encoder 104 can adjust to account for different data types included in a digital asset.

Also as appropriate, acts 204, 205, and 206 can be repeated for other portions of digital asset 111 in addition to (and either prior to or subsequent to) the portion of digital asset 111 that was converted into graphical series 119. Thus, other portions of digital asset 111 can be encoded to include content control data (e.g., DRM data and/or CA data) and quilted into image 123, such as, for example, at row 131A, column 132, etc.

As such, in some embodiments, a computer system encodes a single (or reduced number of) larger 2D graphic representation(s).

Alternately, in other embodiments, a computer system decodes a portion of a larger 2D graphic representation and re-encodes the portion of the larger 2D graphic representation into a plurality of smaller 2D graphic representations (each representing a portion of a digital asset).

Two dimensional images can be lossless relative to corresponding digital assets. For example, a raw video data can be converted to a two dimensional video quilt losslessly. Further, by taking redundancies between successive graphic image representations into account, embodiments of the invention can reduce resource consumption when storing and transmitting digital assets. For example, a resulting lossless two dimensional image representing raw audio data can consume approximately ⅛^{th} the resources as the raw audio data itself. Lossy reductions for video data can be even more significant. For example, a lossy two dimensional image representing raw video data (e.g., a movie) can consume approximately 1/200^{th} the resources as the raw video data itself.

Lossless encoders as well as lossy encoders can be used when placing content control data into a two dimensional images at a variety of bit depths (e.g., 2 bit through 32 bit) and using a variety of file standards (e.g., BIP, BIL, and BSQ).

Accordingly, embodiments of the invention include using steganography and/or expressly concealing content control data, such as, for example, DRM data and/or CA data , within a two dimensional image. Content control data can be embedded at any and all resolutions contained within a two dimensional image. Content control data can be distributed across part of an image or across the whole of an image.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system including one or more processors and system memory, a computer-implemented method for encoding a digital asset along with content control data as an image, the method comprising:
an act of staging a digital asset;
an act of selecting conversion properties for the digital asset, the conversion properties including image properties for a two dimensional image, having one or more rows and one or more columns, that is to store portions of the digital asset, the image properties including a row size that indicates the size for any rows in the two dimensional image and including a column size that indicates the size for any columns in the two dimensional image, the conversion properties also including content control data for implementing content control for the digital asset; and
an act of quilting the digital asset and the content control data into the one or more rows and one or more columns of the two dimensional image, for at least a subset of the portions of the digital asset that are to be stored in the two dimensional image quilting including:
an act of converting the portion of the digital asset into a series of graphic representations in accordance with the selected conversion properties;
an act of replacing part of at least one graphical representation included in the series of graphic representations with a portion of the content control data; and
an act of encoding the portion of content control data data into the two dimensional image by encoding the series of graphic representations into a row and column of the two dimensional image.

2. The method as recited in claim 1, further comprising an act of identifying redundancies between successive graphic representations in the series of graphic representations prior to encoding; and
wherein the act of encoding the portion of rights management data into the two dimensional image by encoding the series of graphic representations into a row and column of the two dimensional image comprises an act of encoding the series of graphic representations taking into account the identified redundancies so as to reduce the size of the digital asset.

3. The method as recited in claim I, wherein the act of staging a digital asset comprises an act of staging a digital asset selected from among: imagery data, audio data, video data, gaming data, broadcast data, financial data, trading data, radio data, and geo-spatial data.

4. The method as recited in claim 1, wherein the act of selecting conversion properties for the digital asset comprises an act of selecting one or more of: data rate frequency, bit depth, number of channels, processing type, data type, scan type, and encoding scheme for the two dimensional image.

5. The method as recited in claim 1, wherein the act of quilting the digital asset and the content control data into the one or more rows and one or more columns of the two dimensional image comprises an act of quilting the digital asset and the content control data into one of: sets of one or more one dimensional single image frames, two dimensional single image frames, a three dimensional image set, a two dimensional image and Lidar set, a two dimensional image and point cloud set, or a film strip set.

6. The method as recited in claim 1, wherein the act of quilting the digital asset and the content control data into the one or more rows and one or more columns of the two dimensional image comprises an act of quilting the digital asset and the content control data into a video quilt.

7. The method as recited in claim I, wherein the act of quilting the digital asset and the content control data into the one or more rows and one or more columns of the two dimensional image comprises an act of quilting the digital asset and the content control data into one of: a single channel audio image, an image quilt of a stereo paired audio signal, or an image quilt of three or more audio channels.

8. The method as recited in claim 1, wherein an act of converting the portion of the digital asset into a series of graphic representations in accordance with the selected conversion properties comprises an act of converting one of: video frames, sound, game textures, or geospatial data into a series of graphic representations.

9. The method as recited in claim 1, further comprising an act of staging the series of graphic representations for sub-areas and sub-resolutions.

10. The method as recited in claim 1, further comprising an act of staging the series of graphic representations for storage in a hierarchical pyramidal space, the hierarchical pyramidal space transmittable level by level from lower resolution data at a lower bandwidth filled by one or more higher resolutions.

11. The method as recited in claim 1, further comprising an act of staging the series of graphic representations to transmit different resolutions based on transmission capabilities.

12. The method as recited in claim 1, wherein the act of replacing part of at least one graphical representation included in the series of graphic representations with a portion of the content control data comprises an act of placing content control data into audio data in a way that the digital rights management data is inaudible.

13. The method as recited in claim 1, wherein the act of replacing part of at least one graphical representation included in the series of graphic representations with a portion of the content control data comprise an act of placing content control data into video data in a way that the digital rights management data is not visible.

14. The method as recited in claim 1, wherein the content control data includes one or more of: digital rights management data, content access data, and geospatial tracking data.

15. A computer program product for use at a computer system, the computer program product for implementing a method for encoding a digital asset along with control data as an image, the computer program product comprising one or more computer storage devices having stored thereon computer-executable instructions that, when executed at a processor, cause the computer system to perform the method, including the following:
stage a digital asset;
select conversion properties for the digital asset, the conversion properties including image properties for a two dimensional image, having one or more rows and one or more columns, that is to store portions of the digital asset, the image properties including a row size that indicates the size for any rows in the two dimensional image and including a column size that indicates the size for any columns in the two dimensional image, the conversion properties also including content control data for implementing content control for the digital asset; and
quilt the digital asset and the content control data into the one or more rows and one or more columns of the two dimensional image, for at least a subset of the portions of the digital asset that are to be stored in the two dimensional image quilting including:
convert the portion of the digital asset into a series of graphic representations in accordance with the selected conversion properties;
replace part of at least one graphical representation included in the series of graphic representations with a portion of the content control data; and
encode the portion of content control data into the two dimensional image by encoding the series of graphic representations into a row and column of the two dimensional image.

16. The computer program product as recited in claim 15, further comprising computer-executable instructions that, when executed, cause the computer system to identify redundancies between successive graphic representations in the series of graphic representations prior to encoding; and
wherein computer-executable instructions that, when executed, cause the computer system to encode the portion of rights management data into the two dimensional image by encoding the series of graphic representations into a row and column of the two dimensional image comprise computer-executable instructions that, when executed, cause the computer system to encode the series of graphic representations taking into account the identified redundancies so as to reduce the size of the digital asset.

17. The computer program product as recited in claim 15, wherein computer-executable instructions that, when executed, cause the computer system to replace part of at least one graphical representation included in the series of graphic representations with a portion of the content control data comprise computer-executable executable instructions that, when executed, cause the computer system to place content control data into audio data in a way that the digital rights management data is inaudible.

18. The computer program product as recited in claim 15 wherein computer-executable instructions that, when executed, cause the computer system to replace part of at least one graphical representation included in the series of graphic representations with a portion of the content control data comprise computer-executable instructions that, when executed, cause the computer system to place content control data into video data in a way that the digital rights management data is not visible.

19. The computer program product as recited in claim 15, wherein the content control data includes one or more of: digital rights management data, content access data, and geospatial tracking data.

20. A computer system, the computer system comprising:
one or more processors;
system memory;
one or more computer-readable storage devices having stored there one computer-executable instructions representing a quilting module, the quilting module configured to:
stage a digital asset;
select conversion properties for the digital asset, the conversion properties including image properties for a two dimensional image, having one or more rows and one or more columns, that is to store portions of the digital asset, the image properties including a row size that indicates the size for any rows in the two dimensional image and including a column size that indicates the size for any columns in the two dimensional image, the conversion properties also including content control data for content control for the digital asset; and
quilt the digital asset and the content control data into the one or more rows and one or more columns of the two dimensional image, for at least a subset of the portions of the digital asset that are to be stored in the two dimensional image quilting including:
convert the portion of the digital asset into a series of graphic representations in accordance with the selected conversion properties;
replace part of at least one graphical representation included in the series of graphic representations with a portion of the content control data; and
encode the portion of content control data into the two dimensional image by encoding the series of graphic representations into a row and column of the two dimensional image.

21. The computer system as recited in claim 19, wherein the quilting module is further configured to transform the series of graphic representations into a space that is structured in a multi-level, multi-resolution format and includes digital rights management data for each level and resolution in the multi-level, multi-resolution format.

22. The computer system as recited in claim 21, wherein the quilting module being configured to transform the series of graphic representations into a space that is structured in a multi-level, multi-resolution format comprises the quilting module being configured to read a line of data, process the line of data into a horizontal hierarchical buffer, and generate a plurality of down sampled subsets.

23. The system as recited in claim 20, wherein the content control data includes one or more of: digital rights management data and content access data.
